(19) United States
(12) Patent Application Publication
(10) Pub. No.: US 2026/0138322 A1
(43) Pub. Date: May 21, 2026

(54) PINNING DEVICE, CASTING UNIT AND MACHINE

(71) Applicant: Brückner Maschinenbau GmbH, Siegsdorf (DE)

(72) Inventor: Peter MAURER, Rohrdorf (DE)

(21) Appl. No.: 19/395,917

(22) Filed: Nov. 20, 2025

(30) Foreign Application Priority Data
Nov. 21, 2024 (DE) 10 2024 134 353.2

(51) Int. Cl. B29C 48/88; B29C 48/00; B29C 48/08

(52) U.S. Cl. CPC B29C 48/9165; B29C 48/0018; B29C 48/08; B29C 48/914

(57) ABSTRACT

An pinning device for electro-statically attaching a film to a cooling roller has a first fastening unit, a second fastening unit, an attachment region located between the fastening units, a high-voltage source, an electrode, at least one insulating device and at least one vibration absorber. The at least one insulating device extends from the associated fastening unit to the film section. The electrode runs from the first fastening unit to the second fastening unit in the attachment region and through the at least one insulating device, and the electrode is subjected to high voltage by the high-voltage source. The vibration absorber is fastened to the at least one insulating device and is designed to absorb vibrations of the electrode.

### CROSS REFERENCE TO RELATED APPLICATION

This application claims priority to German Patent Application Number DE 10 2024 134 353.2, filed Nov. 21, 2024, the entire contents of which is hereby incorporated by reference.

### FIELD OF THE DISCLOSURE

The disclosure relates to a pinning device for electro-statically attaching a film to a cooling roller, to a corresponding casting unit and to a machine having such a casting unit.

### BACKGROUND

When producing thin plastic films, initially a film of a plastic melt is deposited onto a cooling roller on which it cools and solidifies. In order to ensure homogeneous cooling and thus homogeneous material characteristics, it is necessary that the film lies uniformly on the cooling roller over its entire width and continuously over its length.

In order to avoid deformation of the film due to mechanical solutions used for its application, it is known to use electrodes to create an electric field with high field strengths near the cooling roller surface, which the film has to go through. Due to the electric field, the polar molecules of the film are aligned. It creates an electro-static attraction between the film and the cooling roller, so that the film is attached evenly and automatically to the cooling roller.

To create such an electric field with strong field strengths, however, a large high voltage of 8 kV or more is needed at the electrodes, that could lead to sparking between the electrodes and the cooling roller. Such sparking damages the surface of the cooling roller and also reduces the quality of the produced film.

### SUMMARY

Therefore, it is provided a pinning device, a casting unit and a unit, in which sparking is reduced.

It is provided a pinning device for electro-statically attaching a film to a cooling roller, having a first fastening unit, a second fastening unit, an attachment region located between the fastening units, a high-voltage source, an electrode, at least one insulating device and at least one vibration absorber. The at least one insulating device extends from the associated fastening unit to the film section. The at least one electrode runs from the first fastening unit to the second fastening unit in the attachment region and through the at least one insulating device, and the electrode is subjected to high voltage by the high-voltage source. The vibration absorber is fastened to the at least one insulating device and is designed to absorb vibrations of the electrode.

Due to the vibration absorber, vibrations of the insulating device and thus also vibrations of the electrode, which invariably occur during operation of the unit, are quickly absorbed, so that such vibrations both decay quickly as well as have lower amplitudes. Therefore, this avoids distances occurring between the electrode and the cooling roller that are too low, which would lead to arcing, and also makes immersing of the electrode into the melt plume from the nozzle almost impossible. Also, large changes in the distance between the electrode and the cooling roller are avoided in this manner, which would be transferred to the attaching force and thus would negatively affect the visual and/or qualitative characteristics of the film.

In one aspect, the vibration absorber has a natural frequency which corresponds to a natural frequency of the electrode, in particular the lowest natural frequency of the electrode, whereby the vibration absorber can absorb vibrations of the electrode particularly efficiently.

Similarly, it is conceivable that the vibration absorber has several natural frequencies, wherein one, several or all of the natural frequencies correspond to a natural frequency of the electrode.

“Correspond” is understood in this context to mean that the natural frequency of the vibration absorber is the same as the natural frequency of the electrode, or is in the region of plus/minus 10% of the natural frequency of the electrode.

In one embodiment, the vibration absorber has a base, at least one absorber mass and at least one spring connector, wherein the absorber mass is movably fastened to the base by means of the spring connector, in particular wherein the base is fastened to the insulating device. In this manner, a simple and reliable vibration absorber is realised.

The weight of the absorber mass and the distance between the absorber mass and the base are selected in such a way that the vibration absorber has a natural frequency which corresponds to a natural frequency of the electrode.

The vibration absorber can have two absorber masses and two spring connectors, wherein the two absorber masses are identical or different and/or are fastened to the base at the same distance or at different distances from the base by means of the respective spring connector, whereby the one or more natural frequencies of the vibration absorber can be set in a simple manner.

Each absorber mass is fastened to the base by means of a respective one of the spring connectors. In particular, the absorber masses and the base lie on a straight line, wherein the base is arranged between the two absorber masses.

The vibration absorber can have two different natural frequencies, for example when the absorber masses are arranged with the same weight at a different distance from the base.

For further simplification of the construction, the at least one absorber mass can be a weight and/or the at least one spring connector can be a resilient bar.

In one embodiment, the pinning device has two insulating devices which extend from each one of the opposing fastening units towards each other. Due to the insulating device, arcing on the cooling roller can be reliably avoided.

The insulating devices extend, for example, exclusively outside the film section or overlap with the film or the film section in an overlapping region of 2 mm to 15 mm.

For example, the insulating devices are insulating tubes, insulating covers and/or insulating sleeves.

For particularly effective absorption, the vibration absorber, in particular the base, can be fastened to the insulating device.

For example, the vibration absorber, in particular the base, is screwed to the insulating device, is clamped to the insulating device, is bonded to the insulating device and/or plugged onto the insulating device.

In one aspect, the at least one electrode is band-shaped or wire-shaped, in particular a wire, whereby the electric field can be specifically shaped. In particular, the use of band-shaped electrodes lead to a particularly homogeneous electric field, whereby the high voltage reduces—with the same attaching effect—and thus arcing can be reduced.

In one embodiment, the at least one electrode can be moved in its longitudinal direction between the first fastening unit and the second fastening unit, in particular wherein at least one rotatable coil on which the at least one electrode is partially wound is provided in the first and in the second fastening unit. Therefore, deposits on the electrode, which affect the quality of the electric field, can be removed.

In one aspect, the attachment region has a film section which, in the axial direction, corresponds to the section of the cooling roller in which the film is deposited, wherein the at least one vibration absorber is arranged outside the film section. Due to this arrangement, damage of the film by the vibration absorber is eliminated.

For particularly reliable absorption of the vibrations, two vibration absorbers can be present for each electrode, wherein the vibration absorbers are arranged on different sides of the film section.

In order to design the electric field to be even more homogeneous, the pinning device can have at least two electrodes, at least two insulating devices and at least two vibration absorbers, wherein the vibration absorbers are fastened to the insulating devices of different electrodes, in particular wherein the vibration absorbers for different electrodes are arranged on the same or different sides of the film section.

The first electrode can be band-shaped or wire-shaped, in particular be a wire, and/or the second electrode can be band-shaped or wire-shaped, in particular be a wire.

For example, the electrodes run parallel to each other and/or each have two side surfaces, wherein the electrodes face towards each other with each of their side surfaces.

In one embodiment, the first fastening unit and/or the second fastening unit has a damping device which is set up to damp vibrations of the electrode in the attachment region. The damping devices lead to the vibrations decaying even more quickly.

In one aspect, the damping device has a damping roller, the rotational axis of which is perpendicular to the longitudinal direction and perpendicular to the direction of the width of the electrodes, wherein the damping roller is movably mounted in the direction of the width and lies on an edge of each of the electrodes, in particular on the edge facing away from the cooling roller.

For example, the damping device has a damping roller for each electrode, the rotational axis of which is perpendicular to the longitudinal direction and parallel to the direction of the width of the electrode, in particular wherein each of the electrodes rest on one of the damping rollers.

The insulating device can be fastened to the damping device by means of at least one damper consisting of an elastic material.

It is also provided a casting unit having a slot die, a cooling roller and a pinning device, as described above, in particular wherein the cooling roller is grounded.

Further, there is provided a unit for producing a film, having a casting unit as described above and a stretching unit, in particular a transverse, longitudinal and/or simultaneous stretching unit, having a furnace.

The features and advantages described for the pinning device similarly apply to the casting unit and/or the unit and vice versa.

### BRIEF DESCRIPTION OF THE DRAWINGS

Additional features and advantages of the disclosure are found in the following description as well as the attached drawings to which reference is made. In the drawings:

FIG. 1 is a schematic view of a unit according to an embodiment of the disclosure having a cooling roller unit according to an embodiment of the disclosure;

FIG. 2 is the cooling roller unit according to FIG. 1 having a pinning device according to an embodiment of the disclosure in a schematic perspective illustration;

FIG. 3 is a schematic illustration of the pinning device according to FIG. 2;

FIG. 4 is a perspective illustration of an insulating device of the pinning device according to FIG. 2 with vibration absorber fastened thereon;

FIG. 5 is the vibration absorber according to FIG. 4 in a perspective view;

FIG. 6 is a vibration absorber according to a second embodiment in a side view;

FIGS. 7a, 7b are in each case two diagrams of the deflection in a vertical and horizontal direction of the electrode after excitation on a pinning device without (top) or with (bottom) a vibration absorber, respectively;

FIG. 8 is a perspective view of one of the fastening units according to FIG. 2;

FIG. 9 is a damping device of the fastening unit according to FIG. 8;

FIG. 10 is a vibration absorber of a pinning device according to a third embodiment of the disclosure; and,

FIG. 11 is a cross-section through an electrode and an insulating device according to a fourth embodiment of the disclosure.

### DETAILED DESCRIPTION

Lists having a plurality of alternatives connected by “and/or”, for example “A, B and/or C” are to be understood to disclose an arbitrary combination of the alternatives, i.e. the lists are to be read as “A and/or B and/or C” or as “at least one of A, B or C”. The same holds true for listings with more than three items.

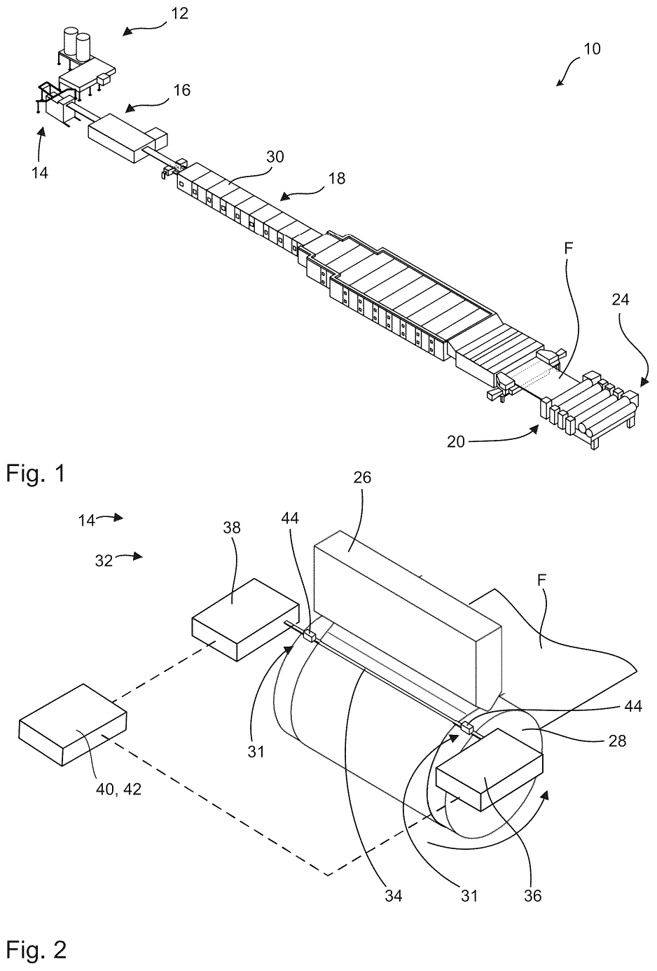

In FIG. 1, a machine 10 or unit for producing a film F is illustrated extremely schematically, which comprises several different machines and devices.

The machine 10 is, for example, a sequential film production machine, on the basis of which—without limiting the scope of protection—the disclosure is explained by way of example.

In the example shown, the machine 10 has an extrusion machine 12, a casting unit 14, at least one longitudinal stretching machine 16 (MDO, “Machine Direction Orienter”), a transverse stretching machine 18 (TDO, “Transverse Direction Orienter”), a treatment device 20, and a winding device 24.

The extrusion machine 12 has an extruder and is set up to create a melt from at least one starting product.

For example, the extruder or extruders is/are (a) single-screw extruder(s), cascade extruder(s) and/or twin-screw extruder(s).

It is also conceivable that other mixing and processing assemblies, such as a busbar or a planetary roller extruder are used.

The melt is deposited onto a cooling roller 28 of the casting unit 14 by means of a slot die 26, whereby a film F is created.

Similarly, it is possible to create the melt by means of polymerisation. For this purpose, the monomers (and optionally additives, such as catalysts) are mixed and polymerised in a reactor and/or an extruder of the extrusion machine 12. The emerging polymerised melt can then be directly deposited onto the cooling roller 28 of the casting unit 14 via the nozzle 26, whereby the film F is created.

The created film F can have one or more layers. It is conceivable with a multi-layered film that one extruder creates several or all layers, or that one extruder is provided for each layer.

Subsequently, the film F is fed to the longitudinal stretching machine 16 and is stretched there in the longitudinal direction.

The transverse stretching machine 18, such as is described in DE 10 2021 128 332 A1, for example, has a furnace 30 having different zones for temperature control of the film F along the typical movement or draw-off direction of the machine 10.

In the furnace 30, the film F is heated in a known manner, and is stretched by the transverse stretching machine 18 in the transverse direction, whereby a monoaxially or, as in the exemplary embodiment, biaxially oriented film is produced.

The optional treatment device 20 is, for example, a device for activating the surface of the film F by a corona treatment, for example in order to realise improved metal adhesion. The corona treatment can take place on one side or both sides.

The winding device 24 serves to wind up the created film F and is the last device in the draw-off direction. It has a winding sleeve on which the film F is wound.

In FIG. 2, the casting unit 14 (also called cooling roller unit) is illustrated in an enlarged schematic view.

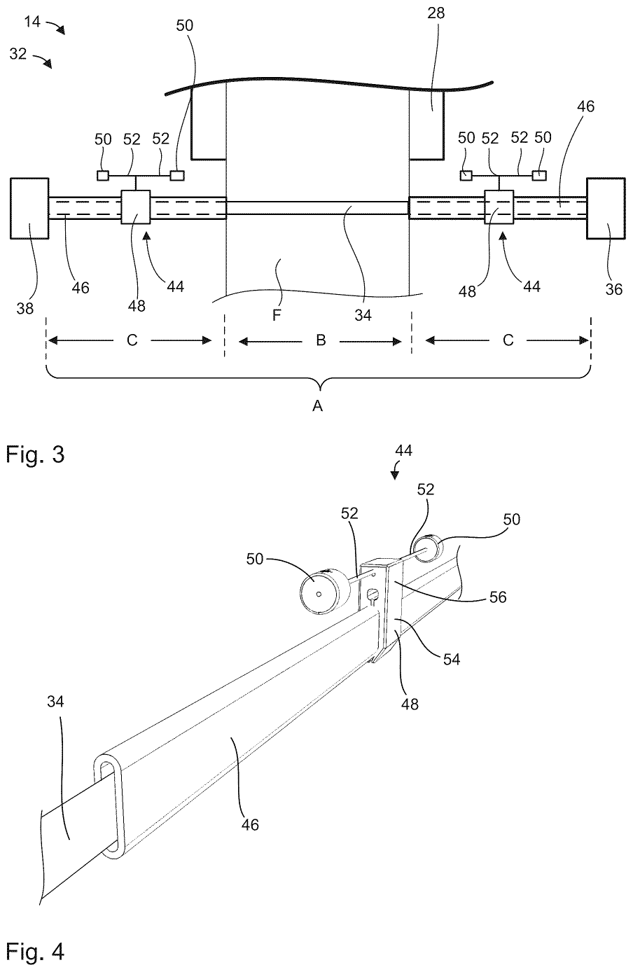

The casting unit 12 shown here comprises the slot die 26, the cooling roller 28 and an pinning device 32. FIG. 3 shows a schematic illustration of the pinning device 32.

The cooling roller 28 is cooled and therefore is also called “chill roll”.

The slot die 26 is arranged above the cooling roller 28 and is designed to continuously deposit the plastic melt, which forms the film F, on the cooling roller 28. The used plastic is in particular a polyethylene terephthalate (PET). The use of other plastics is similarly conceivable.

The film F is then uniformly attached to the cooling roller 28 by means of the pinning device 32. The cooling roller 28 rotates anti-clockwise in the view according to FIG. 2. In the exemplary embodiment shown, after about three-quarters of a turn of the cooling roller 28, the film F created in this manner is lastly removed from the cooling roller 28, if necessary further cooled and fed to the longitudinal stretching machine 16.

The pinning device 32 is an electro-static pinning device and has at least one electrode 34, two fastening units, specifically a first fastening unit 36 and a second fastening unit 38, an optional low-voltage source 40, a high-voltage source 42, at least one vibration absorber 44 and at least one insulating device 46.

In the exemplary embodiment shown, the low-voltage source 40 and the high-voltage source 42 are designed as a device. The low-voltages source 40 and the high-voltage source 42 can also be designed as separate devices.

The fastening units 36, 38 are arranged in the axial direction of the cooling roller 28 in front of or behind the cooling roller 28. An attachment region A is designed between the two fastening units 36, 38. The attachment region A, similarly viewed in the axial direction of the cooling roller 28, has a section, called film section B, which corresponds to the region of the film F on the cooling roller 28. For example, the film section B is that section of the attachment region A which corresponds to the section of the cooling roller 28 in the axial direction in which the film F is deposited onto the cooling roller 28.

The film section B is in particular spaced apart from the fastening units 36, 38, so that the attachment region A has two outer sections C, which in each case are arranged between the film section B and one of the fastening units 36, 38.

The electrode 34 is respectively fastened in each of the fastening units 36, 38 and extends between the two fastening units 36, 38, i.e. also through the attachment region A.

The electrode 34 is, for example, as in the exemplary embodiment shown, band-shaped, i.e. it has a width which is a lot longer than its thickness, in particular by an order of magnitude longer. Additionally, in its longitudinal direction, it has a length, which is greater by orders of magnitude than its width.

Thus, the electrode 34 has two side surfaces which extend in the longitudinal direction of the electrode 34 and in the direction of its width, and two edges. One of the edges is facing towards the cooling roller 28 and one of the edges is facing away from the cooling roller 28. The direction between the edges of the same electrode 34 is referred to as the direction of the width of the electrode 34. In particular, the direction of the width for the electrode 34 corresponds to the radial direction of the cooling roller 28.

The electrode 34 has, for example, a width between 3 mm and 15 mm, in particular a width of more than or equal to 4 mm and of less than 13 mm. For example, a width of 12.7 mm is conceivable.

It is conceivable that the electrode 34 is not designed as a band, but wire-like, i.e. for example round, in particular as a wire. Additionally, almost any other cross-sections of the electrode 34 are conceivable.

The electrode 34 is arranged after the slot die 26 in the rotational direction of the cooling roller 28. For example, the electrode 34 has a distance from the cooling roller 28 of at least the thickness of the film F on the cooling roller 28, for example of at least 2 mm. At most, the electrode 34 has a distance from the cooling roller 28 of 20 mm.

The electrode 34 is subjected to a high voltage by the high-voltage source 42. The high voltage is, for example, between 5 kV and 10 kV, in particular between 7 kV and 9 kV.

The cooling roller 28 is grounded so that a strong electric field through which the film F is guided occurs in the attachment region A.

Additionally, a low electric current forms, which is called a pinning current. At a high voltage of 20 kV, the current is at about 30 mA, for example. At a high voltage of 9 kV, a current of about 12 mA can occur.

Should the electrode 34 break, the high-voltage source is switched off. Breakage of the electrode 34 can take place due to the high-voltage source by means of edge detection.

Similarly, the electrode 34 can be subjected to a low voltage by to the low-voltage source 40. The low voltage is, for example, less than 150 V, in particular between 60 V and 130 V, for example 120 V. The high voltage and the low voltage cascade accordingly.

Also, in addition to the electrode 34, the second hollow insulating devices 46 are provided which are fastened to the fastening units 36, 38 opposite each other.

The insulating devices 46 extend for example, as in the embodiment shown, originating from each of the fastening units 36, 38 towards each other.

The insulating devices 46 extend through the outer section C of the attachment region A to the film section B. The insulating devices 46 thus cover the entire outer section C, in order to avoid arcing on the cooling roller 28, which could damage this, and extend in particular exclusively outside the film section B. Alternatively, the insulating devices 46 can overlap the film section B, for example with an overlap from 2 mm to 15 mm for each of the insulating devices 46.

Similarly, it is conceivable that the insulating devices 46 do not cover the entire outer section C, but end spaced apart from the film section F.

The electrode 34 runs in the region between the fastening units 36, 38, i.e. in the attachment region A successively through both the insulating devices 46. More specifically, the electrode 34 enters the insulating device 46 originating from the first fastening unit 36 and runs in the outer section C inside the insulating device 46. At the end of the insulating device 46, the electrode 34 exits from the insulating device 46 and then runs bare through the film section B.

At the beginning of the other insulating device 46 in the other outer section C, the electrode 34 dips into the other insulating device 46 and runs therein up to the fastening unit 38.

It is also conceivable that the electrode 34 can be moved in its longitudinal direction between the two fastening units 36, 38. For this purpose, as described for the following embodiments, a rotatable coil on which the electrode 34 is partially wound is provided in the first fastening unit 36 and in the second fastening unit 38. In this context, reference is also made to coil units instead of fastening units.

The electrode 34 is mechanically tensioned between the fastening units 36, 38, for example with a force of 200 N. Depending on this mechanical tension, the width of the electrode 34 and the length of the attachment region A, the electrode 34 has a specific natural frequency.

In FIG. 4, a perspective view of one of the insulating devices 46 and the electrode 34 is shown by way of example, wherein similarly one of the vibration absorbers 44 is illustrated. The corresponding fastening unit 36, 38 has been omitted for reasons of clarity.

The electrode 34 is arranged so as to be freely movable inside the insulating device 46 and can be moved through the insulating device 46.

As can be seen, the insulating device 46 is, for example, an insulating tube, an insulating cover and/or an insulating sleeve. It has a longitudinal cross-section, which is approximately rectangular. For example, the corners are rounded or the short sides are formed by curved sections.

The inner diameters of the insulating devices 46 in their longitudinal direction correspond here to the width of the electrode 34, so that the electrode 34 can be guided in the insulating devices 46.

In the exemplary embodiment shown, the insulating devices 46 each completely surround the received electrode 34 along its circumference.

However, it is also conceivable that the electrode 34 is not completely enclosed, as long as its side facing towards the cooling roller 28 is enclosed by the respective insulating device 46.

The insulating devices 46 are produced from a plastic, in particular from polyether ether ketone, PEEK. In particular, the PEEK is a tempered PEEK. Insulating devices 46 consisting of tempered PEEK have proven to be particularly durable. Other materials for producing the insulating devices 46 are also conceivable, for example polytetrafluoroethylene (PTFE), polyphthalamide (PPA) or polyether ketones (PEK), as long as they have a sufficiently high dielectric strength and are dimensionally stable at temperatures of more than 150° C.

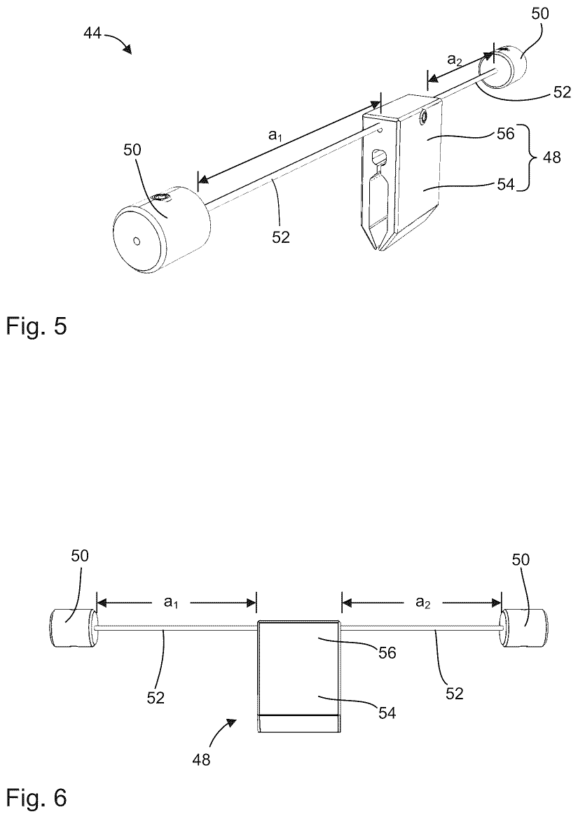

The vibration absorber 44 is fastened on the insulating device 46. In FIG. 5, the vibration absorber 44 is illustrated in a perspective view.

The fastening on the vibration absorber 44 takes place in such a way that the vibration absorber 44 sits firmly on the insulating device 46, but the mobility of the electrode 34 in the insulating device 46 is not affected.

The pinning device 32 has for example, as in the exemplary embodiment shown, two vibration absorbers 44, which are identical in design.

The vibration absorber 44 has a base 48, two absorber masses 50 and two spring connectors 52.

The base 44, like the insulating devices 46, can be produced from a plastic, particular from polyether ether ketone, PEEK. In particular, the PEEK is a tempered PEEK. Other materials for producing the base 44 are also conceivable, for example polytetrafluoroethylene (PTFE), polyphthalamide (PPA) or polyether ketone (PEK), as long as they have a sufficiently high dielectric strength and are dimensionally stable at temperatures of more than 150° C.

The base 48 has a fastening section 54 and a connecting section 56, on which the spring connectors 52 are fixed.

The fastening section 54 and the connecting section 56 can be designed as a single piece together, so that the base 48 is a single piece.

For example, the base 48 is an injection-moulded part or a 3D printed element consisting of plastic. The use of other materials, such as metals or blends of plastic and metal, is similarly possible.

The fastening section 54 serves for the fastening to the insulating device 46 and is designed as a clamp in the exemplary embodiment shown.

In the fastened state, the fastening section 54 engages around the insulating device 46 and thus fastens the vibration absorber 44.

For example, the fastening section 54 designed as a clamp can be reliably closed by means of a screw.

It is conceivable that the base 48 is screwed to the insulating device 46 or is plugged thereon.

Similarly, it is conceivable that the vibration absorber 44 has only one absorber mass 50 or more than two absorber masses 50 or only one spring connector 52 or more than two spring connectors 52.

The absorber masses 50 are designed as weights in the exemplary embodiment shown, for example as a cylinder consisting of a solid material. The material of the absorber masses 50 can be, for example, lead, steel, plastic, aluminium or a mixture of these materials.

Similarly, it is conceivable for the weights to have any other shape, such as a cuboidal, cone-shape or round or spherical.

In the exemplary embodiment shown, the spring connectors 52 are resilient bars.

Each of the absorber masses 50 is fastened to the connecting section 56 of the base 48 by means of the spring connectors 52.

The spring connectors 52 extend in the axial direction, i.e. also parallel to the electrode 34.

For example, the spring connectors 52 extend in opposite directions to each other, so that the absorber masses 50 are similarly opposite to each other in relation to the base 48. The base 48 is thus located between the absorber masses 50 in the axial direction.

The absorber masses 50 and the base 48 lie on a straight line along which the spring connectors 52 extend.

The absorber masses 50 are thereby spaced apart relative to the base 48 and movably mounted, as the spring connectors 52 enable movement of the absorber masses 50.

In the exemplary embodiment shown, one of the absorber masses 50 is arranged at a first distance a₁ and the second absorber mass 50 is arranged at a second distance a₂ away from the base 48.

The vibration absorber 44 has at least one natural frequency which depends on the weight of the absorber mass 50 and its distance a₁, a₂ from the base 48. The vibration absorber 44 can also have several natural frequencies, for example two natural frequencies, as in the exemplary embodiment shown.

In the exemplary embodiment shown, the weights of the absorber masses 50 are identical, however the distances a₁, a₂ are different, whereby two different natural frequencies of the vibration absorber 44 occur.

Similarly, it is conceivable that both the absorber masses 50 as well as the distances a₁ and a₂ of the absorber masses 50 from the base 48 are identical, whereby the vibration absorber 44 has only one natural frequency.

The natural frequency or natural frequencies of the vibration absorber 44 are selected in such a way that it or one of them corresponds to the natural frequency of the electrode 34. For example, “corresponding” in this context means that the natural frequencies corresponding to each other are identical or deviate by at most ±10% from each other.

In particular, the natural frequency of the vibration absorber 44 corresponds to the lowest natural frequency of the electrode 34.

For example, for an electrode 34 having a width of 12 mm, a length of 4.2 m with a mechanical voltage of 200 N, the natural frequency is about 24.8 Hz.

It is also conceivable that the electrode 34 has several natural frequencies. In particular, it has the higher harmonics of the lowest natural frequency as natural frequencies.

For example, one of the natural frequencies of the vibration absorber 44 is 24.8 Hz, whereby the vibration absorber 44 is matched to the aforementioned example of the electrode 34.

In FIG. 6, a vibration absorber 44 of a second embodiment of the pinning device 32 is illustrated. The vibration absorber 44 of this embodiment only has one natural frequency, as the absorber masses 50 are the same weight and are both arranged at the same distance, i.e. a₁=a₂, from the base 48.

As can be seen in FIG. 3, the two vibration absorbers 44 of the pinning device 32 of the embodiment shown are arranged on different sides of the film section B.

During operation of the stretching machine 10, an electrical high-voltage field is generated between the electrode 34 and the cooling roller 28 by means of the pinning device 32, in particular the electrodes 34 subjected to high-voltage. The film F runs through the electric field due to the rotational movement of the cooling roller 28.

Due to the electric field, the surface of the cooling roller 28 is electrically charged and the polar molecules of the plastic material of the film F are aligned. Therefore, an electro-static attraction force between the cooling roller 28 and the film F occurs. Due to this attraction force, the film F is uniformly attached to the cooling roller 28.

During operation of the machine 10, the electrode 34 may vibrate, for example the electrode 34 starts to vibrate as a result of arcing, melt inhomogeneities, unequal distribution of pinning additives, a draught or also other influences due to their length. The electrode 34 then vibrates at its natural frequency.

Due to the fastening of the vibration absorber 44 on the insulating device 46, the vibration is transferred to the vibration absorber 44, and the absorber masses 50 are similarly set in motion, so that the vibration absorber 44 vibrates at its natural frequency. As the natural frequency of the vibration absorber 44 corresponds to the natural frequency of the electrode 34, and the phase of the vibration of the vibration absorber 44 is opposed to the phase of the vibration of the electrode 34, the vibration in the electrode 34 is greatly reduced.

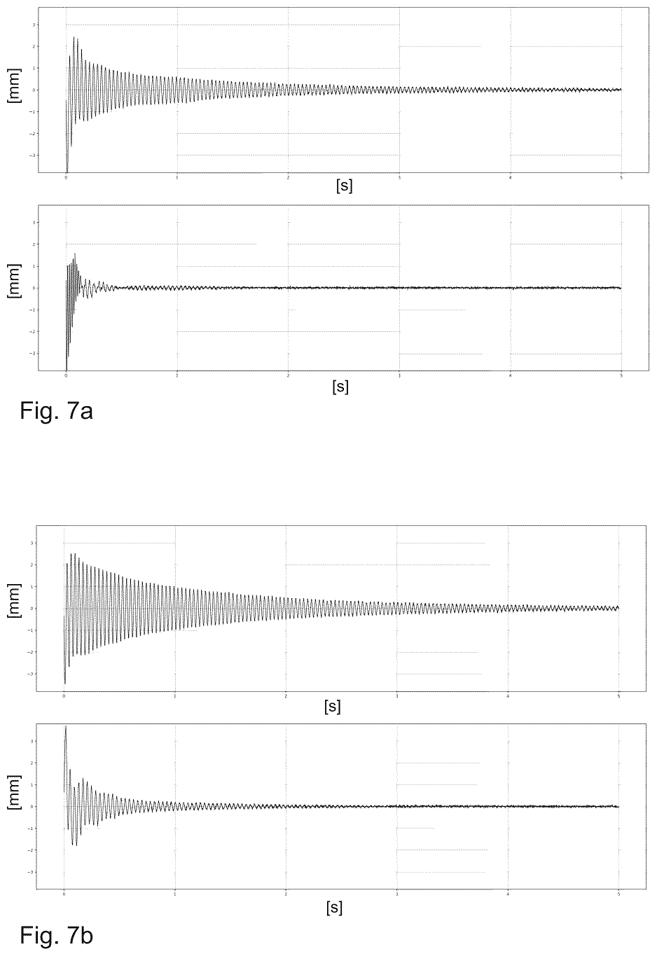

For example, two graphs are illustrated in FIG. 7a, which illustrate the vibrations of the electrode 34 in the vertical direction after an excitation, wherein the lower diagram shows the deflection or amplitude of the electrode 34 of the pinning device 32 with vibration absorber 44 and the upper diagram shows the deflection of an electrode of a pinning device without a vibration absorber.

In a similar manner, two graphs are illustrated in FIG. 7b, which illustrate the vibrations of the electrode 34 in the horizontal direction after an excitation, wherein the lower diagram shows the deflection or amplitude of the electrode 34 of the pinning device 32 with vibration absorber 44 and the upper diagram shows the deflection of an electrode of a pinning device without a vibration absorber.

It can be clearly seen that with pinning devices 32 having a vibration absorber 44, the deflection or the amplitude of the vibration of the electrode 34 is reduced or absorbed significantly faster than is the case without vibration absorbers. For example, a three-times faster decay of the vibrations is achieved.

Thus, arcing between the electrode 34 and the cooling roller 28 is reliably reduced, and the electrode 34 dips into the melt plume from the slot die 26 less often.

Additionally, if provided, during operation the electrode 34 is moved continuously along its longitudinal direction, i.e. unwound in the first fastening unit 36 and wound up in the second fastening unit 38, or vice versa. In this manner, deposits which are produced by evaporations of the plastic material of the film F are removed, whereby the homogeneity of the electric field is increased or remains the same.

Deposits are also reduced by the low voltage applied to the electrodes 34. A current, also called a heating current, is created by the low voltage through each of the electrodes 34 from the first fastening unit 36 to the second fastening unit 38 (or vice versa) with an amperage between 1 A and 8 A.

For example, the amperage through an electrode 34 designed as a 3 mm band is between 2 and 2.5 A and at about 7 A through an electrode 34 designed as a 12.7 mm band. The currents are lower with the use of a wire as an electrode 34.

The electrodes are not grounded, so that a break of the electrode 34 results in an interruption of the current.

Due to the current, the electrode 34 heats up, whereby the evaporations of the plastic material of the film F is deposited less strongly as condensate on the electrode 34.

Thus, the quality of the produced film F can be clearly improved and machine downtimes are significantly reduced.

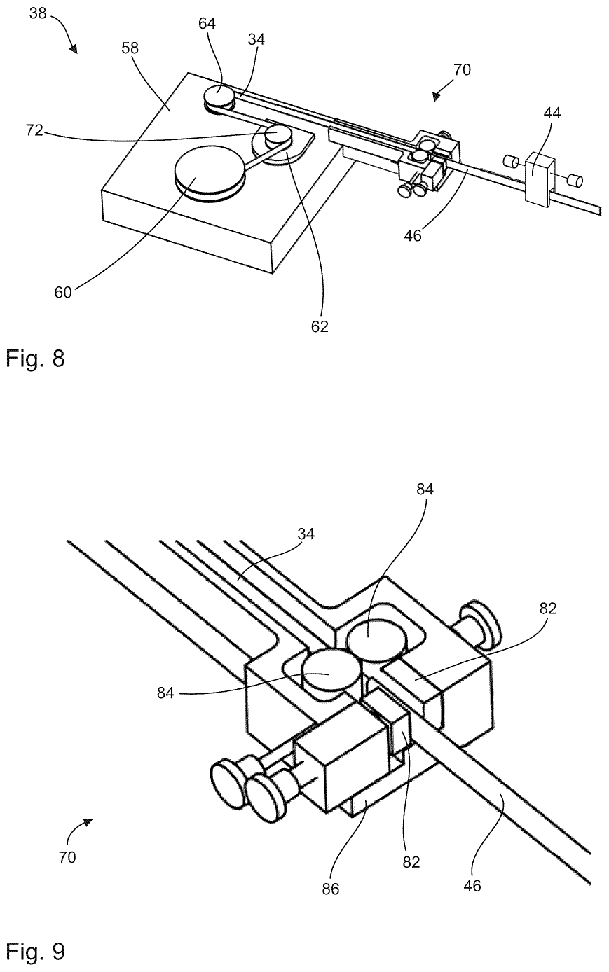

In FIGS. 8 and 9, the fastening units 38 of the pinning device 32 are described, wherein FIG. 8 shows the second fastening unit 38 in an open state, and FIG. 9 shows the fastening of the corresponding insulating device 46 on the second fastening unit 38.

The first fastening unit 36 is designed for this purpose accordingly.

In FIG. 8, the second fastening unit 38 is illustrated open. The second fastening unit 38 is located in relation to FIG. 2 on the left side of the cooling roller 28.

The first fastening unit 36 on the right side of the cooling roller 28 has a substantially identical construction, only it is a mirror image.

The second fastening unit 38 has a housing 58, a rotatable coil 60, a voltage supply device 62, a first guide roller 64, a mechanical tensioning device 66 and a damping device 70.

The electrode 34 is partially wound on the rotatable coil 60 and runs from the rotatable coil 60 to the voltage supply device 62.

The voltage supply device 62 is electrically connected to the high-voltage source 42 and has a roller 72.

The roller 72 guides the electrode 34 and in the process subjects the electrode 34 to the high voltage provided by the high-voltage source 42.

Subsequently, the electrode 34 runs to the first guide roller 64 and from there out of the fastening unit 38 to the attachment region A.

In the first fastening unit 36, the electrode 34 runs in the reverse order as described for the second fastening unit 38 and finally onto a rotatable coil.

The two rotatable coils 60 of the fastening units 36, 38 can be driven. In this manner, the electrode 34 can be moved between the first fastening unit 36 and the second fastening unit 38. For example, the electrode 34 is unwound from the rotatable coil of the first fastening unit 36, runs through the attachment region A into the second fastening unit 38, where it is wound up by the rotatable coil 60 of the second fastening unit 38.

Additionally, the tension or the mechanical stress, and thus the natural frequency, of the electrode 34 can be set by means of the driven rotatable coils 60.

It is also conceivable that several of the electrodes 34 are wound onto the same rotatable coil 60. In this case, for example, a common rotatable coil 60 is provided, which has different regions for the different electrodes 34. The mechanical stress, and thus the natural frequency, of the different electrodes 34 can then be set by a tensioning device for each of the electrodes 34.

The damping devices 70 represent the outlet of the fastening units 36, 38.

The damping devices 70 are provided on an arm 62, which extends from the housing 58 of the respective fastening unit 36, 38 in the direction of the attachment region A.

In particular, the length of arm jib 62 can be adjusted, for example by means of a motor and a rack-and-pinion mechanism.

The insulating devices 46 are fastened on the damping devices 70 by means of a fastening device 80, as can be seen in FIG. 9.

For example, the fastening device 80 has vibration-damping elements 82, such as a damper consisting of elastic material, between which the insulating device 46 is clamped. The clamp can be adjusted by means of a screw, for example.

The damping device 70 is illustrated enlarged in FIG. 9.

The damping device 70 has two damping rollers 84, each of which is fastened to a mounting block 86.

Each mounting block 86 is resiliently mounted perpendicular to the side surfaces of the electrodes 34, so that the damping rollers 84 are also resiliently mounted.

Each of the damping rollers 84 can be rotated about a rotational axis, which is perpendicular to the longitudinal direction and parallel to the direction of the width of the electrode 34. In other words, the rotational axes extend parallel to the side surfaces, but perpendicular to the longitudinal direction of the electrode 34.

The electrode 34 is guided through between the two damping rollers 84, wherein each of the damping rollers 84 touches the side surface of the electrode 34.

The damping device 70 results in a damping of vibrations of the electrode 34 and thus even faster decay of vibrations of the electrode 34.

Other damping devices are also conceivable, for example such as are described in DE 10 2022 118 971 A1.

In a further embodiment, two electrodes 34 can be provided, which each run through at least one insulating device 46. Preferably, however each of the electrodes 34 runs through two insulating devices 46.

In the case of two electrodes 34, at least two vibration absorbers 44 are provided, wherein in each case one vibration absorber 44 is fastened to one of the insulating devices 46 of each of the electrodes 34 and has the natural frequency of the corresponding electrode 34.

The vibration absorbers 44 of the different electrodes 34 can either be arranged on the same side of the film section B, for example next to each other, or on different sides of the film section B, for example opposite each other.

In the case that the two electrodes 34 have different natural frequencies, the same vibration absorbers 44 as described for the first embodiment can nevertheless be used if the two natural frequencies of the vibration absorbers 44 correspond to the different natural frequencies of the two electrodes 34.

It is also conceivable that four vibration absorbers 44 can be used if two electrodes 34 are used, wherein in each case one vibration absorber 44 is provided for each insulating device 46.

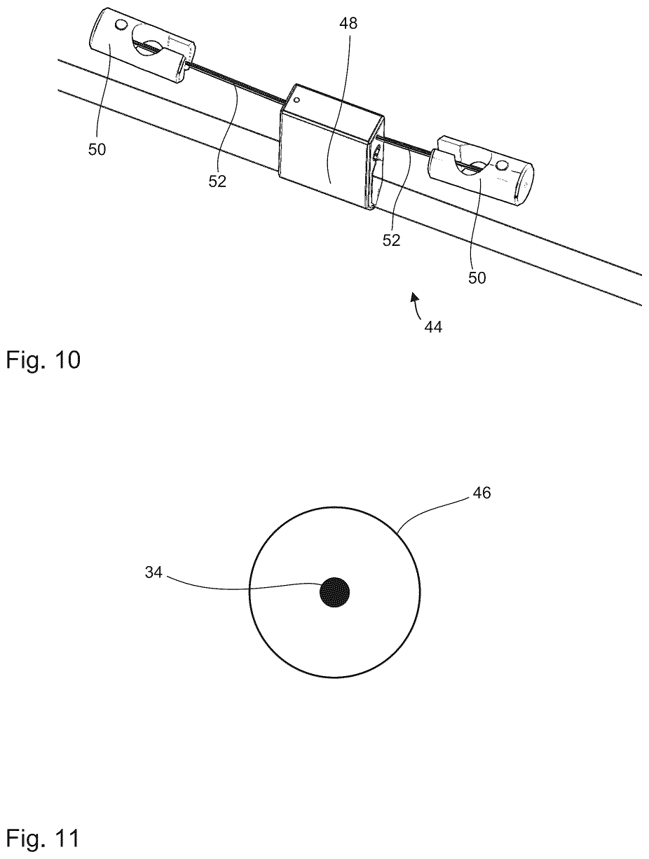

FIGS. 10 and 11 show further embodiments of the disclosure, which substantially correspond to the first or second embodiment. Subsequently, therefore, only the differences will be addressed and identical and functionally identical parts are provided with the same reference numerals.

Although the explanation of the further embodiments refers to the first or second embodiment, the features of all embodiments can be easily combined together.

In FIG. 10, a vibration absorber 44 of a pinning device 32 according to a third embodiment is illustrated in a perspective view.

In this embodiment, the absorber masses 50 are designed in a U-shape, wherein the apex of the U-shape is fastened to the connector 52. The legs of the U-shape extend to the base 48 and can be thicker at their ends.

Such vibration absorbers 44 have four natural frequencies and thus are suitable for many different electrodes 34 and/or installation situations, in particular different mechanical stresses.

In FIG. 11, a cross-section through the electrode 34 and the associated insulating device 46 of a fourth embodiment is shown. In this embodiment, the electrode 34 is a wire having a circular cross-section. Accordingly, the insulating device 46 is adapted to the cross-section of the electrode 34. The insulating device 46 has a ring-shaped cross-section, wherein the electrode 34 runs in the interior of the ring.

1. A pinning device for electro-statically attaching a film to a cooling roller, having a first fastening unit, a second fastening unit, an attachment region located between the fastening units, a high-voltage source, an electrode, at least one insulating device and at least one vibration absorber,
wherein the at least one insulating device extends from the associated fastening unit to the film section,
wherein the electrode runs from the first fastening unit to the second fastening unit in the attachment region and through the at least one insulating device, and the electrode is subjected to high voltage by the high-voltage source, and
wherein the vibration absorber is fastened to the at least one insulating device and is designed to absorb vibrations of the electrode.

2. The pinning device according to claim 1, wherein the vibration absorber comprises a natural frequency which corresponds to a natural frequency of the electrode.

3. The pinning device according to claim 1, wherein the vibration absorber comprises a natural frequency which corresponds to the lowest natural frequency of the electrode.

4. The pinning device according to claim 1, wherein the vibration absorber comprises a base, at least one absorber mass and at least one spring connector, wherein the absorber mass is movably fastened to the base by means of the spring connector.

5. The pinning device according to claim 4, wherein the base is fastened to the insulating device.

6. The pinning device according to claim 4, wherein the vibration absorber comprises two absorber masses and two spring connectors, wherein the two absorber masses at least one of are identical or different or are fastened to the base at an equal distance or at different distances from the base by means of the respective spring connector.

7. The pinning device according to claim 4, wherein at least one of the at least one absorber mass is a weight or the at least one spring connector is a resilient bar.

8. The pinning device according to claim 1, wherein the pinning device comprises two insulating devices, which extend from each of the opposing fastening units towards each other.

9. The pinning device according to claim 1, wherein the at least one electrode is band-shaped, wire-shaped or is a wire.

10. The pinning device according to claim 1, wherein the at least one electrode can be moved in its longitudinal direction between the first fastening unit and the second fastening unit.

11. The pinning device according to claim 10, wherein at least one rotatable coil on which the at least one electrode is partially wound is provided in the first and in the second fastening unit.

12. The pinning device according to claim 1, wherein the attachment region comprises a film section which corresponds to the section of the cooling roller in which the film is attached, wherein the at least one vibration absorber is arranged outside the film section.

13. The pinning device according to claim 12, wherein the pinning device comprises two vibration absorbers, wherein the vibration absorbers are arranged on different sides of the film section.

14. The pinning device according to claim 1, wherein the pinning device comprises at least two electrodes, at least two insulating devices and at least two vibration absorbers, wherein the vibration absorbers are fastened to the insulating devices of different electrodes.

15. The pinning device according to claim 14, wherein the vibration absorbers for different electrodes are arranged on the same or different sides of the film section.

16. The pinning device according to claim 1, wherein at least one of the first fastening unit or the second fastening unit comprises a damping device which is set up to damp vibrations of the electrode in the attachment region.

17. A casting unit, having a slot die, a cooling roller and the pinning device according to claim 1.

18. The casting unit according to claim 17, wherein the cooling roller is grounded.

19. A unit for producing a film, having the casting unit according to claim 17, and a stretching unit having a furnace.

20. The unit according to claim 19, wherein the stretching unit is at least one of a transverse, longitudinal or simultaneous stretching unit.
